(19) United States
(12) Patent Application Publication
(10) Pub. No.: US 2003/0115570 A1
(43) Pub. Date: Jun. 19, 2003

(54) Development environment for building software applications that mimics the target environment

(75) Inventor: John F. Bisceglia, Fairfield, CT (US)

Correspondence Address: Kelly K. Kordzik, 5400 Renaissance Tower, 1201 Elm Street, Dallas, TX, 75270, US

(73) Assignee: International Business Machines Corporation, Armonk, NY (US)

(21) Appl. No.: 10/015,855

(22) Filed: Dec. 13, 2001

(51) Int. Cl. G06F 9/44

(52) U.S. Cl. 717/101; 717/120

(57) ABSTRACT

A method, system and computer program product for creating and managing a development environment that mimics a target environment where the software application may be implemented. Control information, e.g., client standards for the hardware and software components in the target environment, may be used to synchronously detect a problem in the development environment during the process of receiving, reviewing, assigning and processing a request, e.g., request to develop the development environment, request to implement a change in the development environment, request to correct a problem detected in the development environment. Once a violated condition of the control information has been detected, the appropriate developer or team of developers may be notified to correct the problem. By receiving early notification of violated conditions, the development environment and/or software application may be updated thereby reducing the number of problems that need to be corrected after the software application has been deployed.

### TECHNICAL FIELD

The present invention relates to the field of development environments for building software applications, and more particularly to a process for creating and managing a development environment that mimics the target environment where the software application will be implemented.

### BACKGROUND INFORMATION

A development environment may refer to the hardware components, e.g., servers, and software components, e.g., operating systems, required to build the software applications. Once built, the software applications may be deployed in another environment, commonly referred to as the target environment on which the application is implemented. That is, the customer may use the software application in the target environment.

Many developers of software applications establish or arrange a development environment that may not be compliant with the target environment that implements the built software application. Furthermore, developers of software applications are often not aware of the required system updates to ensure that the development environment meets customers' standards for security, virus protection, access control, etc.

As a result, software applications have been developed and deployed without adequately testing the software applications in the target environment. Consequently, these software applications may fail in the target environment resulting in a significant amount of code modification, design changes and/or additional testing.

It would therefore be desirable to have a development process that reduces the costs of correcting problems after the software application has been deployed because the software application is incompatible with the target environment.

### SUMMARY

The problems outlined above may at least in part be solved in some embodiments by creating and managing a development environment that mimics the target environment using control information, e.g., client standards for the hardware and software components in the target environment, thereby reducing the number of problems that need to be corrected after the software application has been deployed.

The development environment may be monitored for violated conditions of the control information prior to the deployment of the software application. Once a violated condition of the control information has been detected, the appropriate developer or team of developers may be notified to correct the problem. By receiving early notification of violations of the conditions as specified by the control information, the development environment and/or software application may be updated thereby reducing the number of problems that need to be corrected after the software application has been deployed. That is, the costs of correcting problems after the software application has been deployed may be reduced.

In one embodiment of the present invention, a method for creating and managing a development environment that mimics a target environment where a software application may be implemented may comprise the step of a server receiving a request issued from customer, developer or team of developers. The request may be a development environment request, a change request or a problem report. A development environment request may comprise a description of the development environment and the software application to be developed. A change request may refer to a description of the change in the development environment to be implemented. A problem report may refer to a description of a problem detected in the development environment including a reference to the particular development environment.

Upon receipt of the request, the request may be transmitted to a sub-process configured to review the request. The request may be rejected, held, returned to the requester or assigned as discussed below. The sub-process configured to review the request may receive control information, e.g., an environment profile, a server profile, a network component profile and/or a statement of work, to manage how to handle the request, e.g., environment request, change request, problem report, as discussed further below. An environment profile may refer to a description of the development environment including the hardware and software components of the development environment as well as the software application to be developed and project business and financial data. A server profile may describe the hardware and software configuration data for an individual server used in the development environment. A network component profile may describe the hardware and software configuration data for any dedicated network component used in the development environment. Furthermore, the sub-process configured to review the request may receive as control information the conditions stated in the statement of work, e.g., customer standards for the hardware and software components in the target environment, contract conditions, etc. A statement of work may refer to the document that provides the detailed description of the project to be completed by the developers.

As stated above, the sub-process configured to review the request may receive control information to manage how to handle the request, e.g., environment request, change request and problem report. The request may be rejected if the request is not submitted by an authorized customer, an authorized developer or an authorized team of developers or if the request is not in compliance with a condition(s) of the statement of work as indicated. Further, the request may be held if there are issues that need to be resolved. For example, the request may be held to ensure that particular contract conditions are met. Furthermore, the request may be returned to the requester if the request is not complete, e.g., additional information is required. Furthermore, the request submitted by an authorized customer or developer or team of developers that contains all the required information as well as satisfying all the conditions of the statement of work may be transmitted to a sub-process configured to assign the request to the responsible development team.

Upon assigning the request to the appropriate development team, the request may be transmitted to a sub-process configured to process the request. The sub-process configured to process the request may receive as input the request that is ready to be processed by the responsible development team in accordance with the control information provided by a statement of work, a server profile, a network component profile and/or an environment profile. Upon processing the request, the request may be completed. Furthermore, the sub-process configured to process the request may update changes, if any, to the development environment in the environment profile, the server profile and/or the network component profile.

The sub-processes described above may occur in a synchronously manner. During their operation, the following discussed sub-processes may occur in an asynchronous manner configured to detect and notify of any violated conditions of the control information, e.g., statement of work, thereby providing an early notification of the violation of the conditions as specified by the control information prior to the deployment of the software application. By receiving early notification of violations of the conditions as specified by the control information, the development environment and/or software application may be updated thereby reducing the costs of correcting problems after the software application has been deployed.

A sub-process may be configured to continuously monitor the development environment, including but not limited to, the hardware components, e.g., servers, and the software components, e.g., operating systems, of the development environment. The sub-process configured to monitor the development environment may monitor the development environment via automated monitoring tools. An automated monitoring tool may be configured to monitor particular operating conditions of the development environment. For example, the automated monitoring tools may be configured to monitor the utilization of the memory space or physical disk space of one or more servers in the development environment. Using the conditions as specified in the control information, e.g., server not to utilize 80% of its memory space as specified in the server profile, the automated monitoring tools may monitor these conditions to determine if a condition has been violated.

Once the automated monitoring tools has determined that a condition has been violated, the sub-process may indicate the violated condition in a report which may then be transmitted to a sub-process configured to transmit a report to the customer as described in greater detail below. Further, the sub-process for monitoring violated conditions may be configured to determine the appropriate developer or team of developers to be notified of the violated condition based on the control information, e.g., the environment profile, the server profile, the network component profile. The sub-process for monitoring violated conditions may further issue a notification request to a sub-process configured to notify the appropriate developer or team of developers of the violated condition.

The sub-process configured to notify the appropriate developer or team of developers of the violated condition may notify the appropriate developer or team of developers of the problem according to the contact information provided in the control information, e.g., the environment profile, the server profile, the network component profile. For example, the environment profile may specify to notify the developer or team of developers in question via e-mail. In another example, the environment profile may specify to notify the developer or team of developers in question by being paged.

As stated above, the sub-process configured to monitor the development environment may transmit an indication of a violation of a condition to be inserted in a report to a sub-process configured to issue a report to the customer. The sub-process configured to issue a report to the customer may further be configured to receive as input the status of the development environment from the automated monitoring tools. The automated monitoring tools may be configured to periodically, e.g., once every hour, transmit information to the sub-process regarding the status of the development environment including information that the hardware and software components of the development environment are operating in order. The sub-process configured to issue a report to the customer may subsequently be configured to issue a report to the customer where the report may include violated conditions as reported by the sub-process configured to monitor the development environment as well as the status details of the development environment provided by the automated monitoring tools.

The foregoing has outlined rather broadly the features and technical advantages of one or more embodiments of the present invention in order that the detailed description of the invention that follows may be better understood. Additional features and advantages of the invention will be described hereinafter which form the subject of the claims of the invention.

### BRIEF DESCRIPTION OF THE DRAWINGS

A better understanding of the present invention can be obtained when the following detailed description is considered in conjunction with the following drawings, in which:

FIG. 1 illustrates a network system configured in accordance with the present invention;

FIG. 2 illustrates a server in a network system configured in accordance with the present invention;

FIG. 3 is a process flow diagram for creating and managing a development environment that mimics a target environment where a software application will be implemented in accordance with the present invention;

FIG. 4 illustrates a development environment request in accordance with the present invention;

FIG. 5 illustrates a change request configured in accordance with the present invention;

FIG. 6 illustrates a problem report configured in accordance with the present invention;

FIG. 7 illustrates an environmental profile in accordance with the present invention;

FIG. 8 illustrates a server profile in accordance with the present invention; and

FIG. 9 illustrates a network component profile in accordance with the present invention.

### DETAILED DESCRIPTION

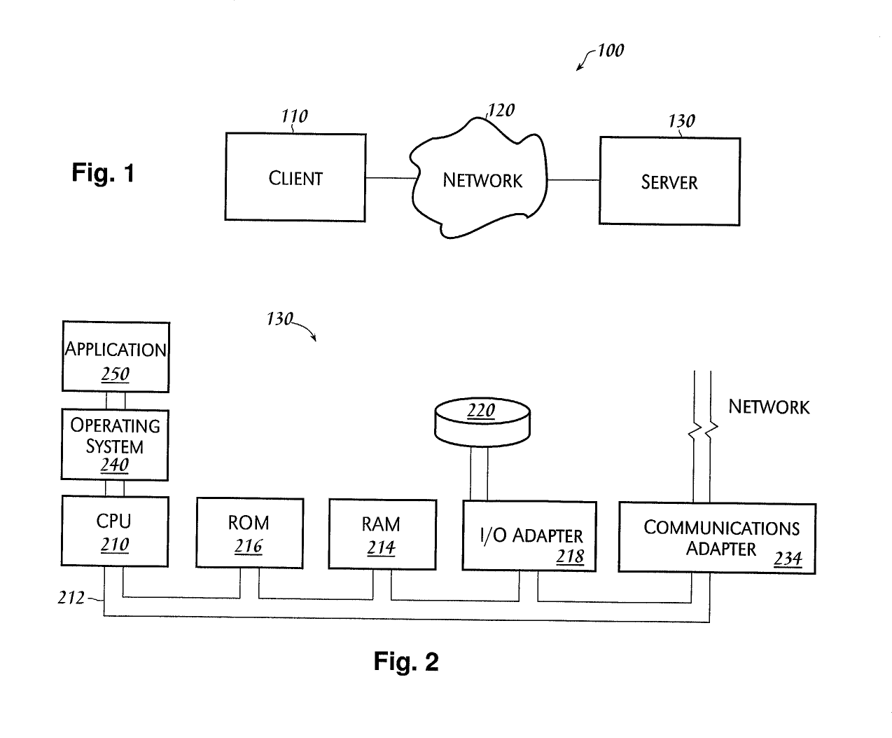

FIG. 1—Network System

FIG. 1 illustrates an embodiment of a network system 100 in accordance with the present invention. System 100 may comprise a client 110 coupled to a server 130 via a network 120. Network 120 may be a Local Area Network (LAN), e.g., Ethernet, Token Ring, ARCnet, or a Wide Area Network (WAN), e.g., Internet. Server 130 may be configured to receive requests issued from a customer at client 110. One such request may be referred to as a “development environment request” which may comprise a description of the development environment and the software application to be developed. Another such request may be referred to as a “change request” which may comprise a description of the change in the development environment to be implemented. Another such request may be referred to as a “problem report” which may comprise a description of a problem in the development environment to be corrected. It is noted that system 100 may comprise any number of clients 110 as well as any number of servers 130 and that FIG. 1 is illustrative. It is further noted that the connection between client 110 and network 120 may be any medium type, e.g., wireless, wired. It is further noted that client 110 may be any type of network access device, e.g., wireless, Personal Digital Assistant (PDA), cell phone, personal computer system, workstation, web terminal, Internet appliance, configured with the capability of connecting to network 120 by either a wired or wireless connection. It is further noted that system 100 may be any type of system that has at least one server 130 and at least one client 110 and that FIG. 1 is not to be limited in scope to any one particular embodiment.

FIG. 2—Server

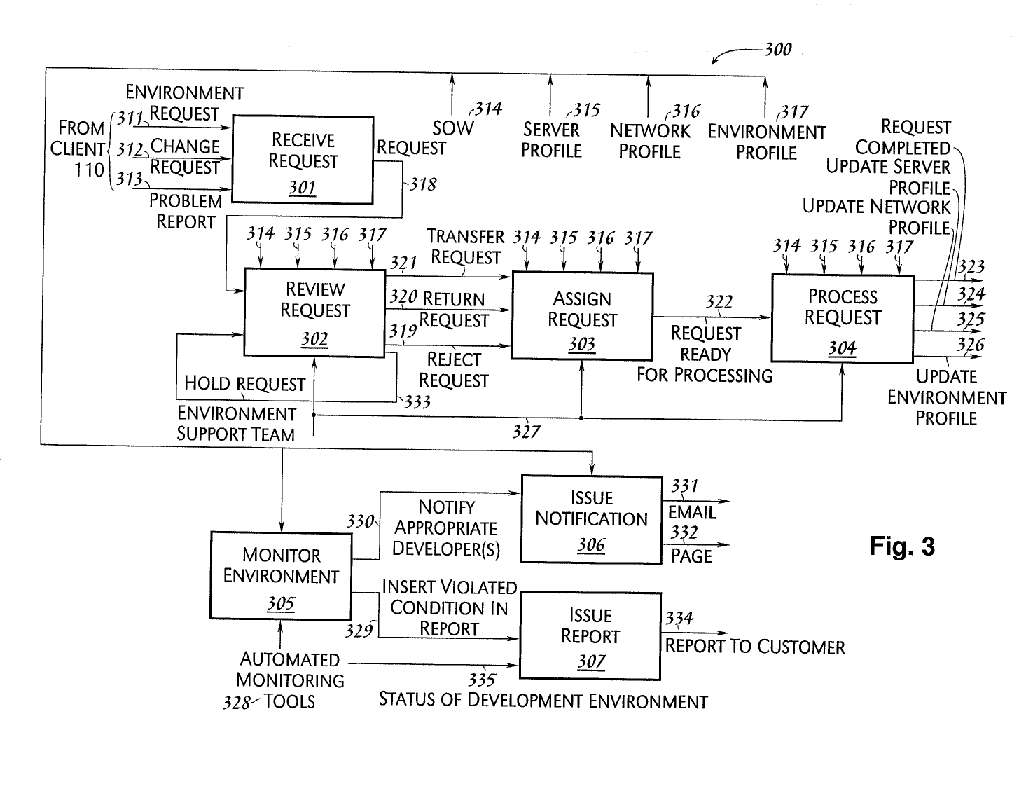

FIG. 2 illustrates an embodiment of the present invention of server 130. Referring to FIG. 2, server 130 may comprise a processor 210 coupled to various other components by system bus 212. An operating system 240 may run on processor 210 and provide control and coordinate the functions of the various components of FIG. 2. An application 250 in accordance with the principles of the present invention may run in conjunction with operation system 240 and which may expose an Application Program Interface (API) to application 250 and provide services thereto. Application 250 may include for example, a program for creating and managing a development environment that mimics the target environment where the software application will be implemented as described in conjunction with FIGS. 3-8.

Referring to FIG. 2, read only memory (ROM) 216 may be coupled to bus 212 and include a basic input/output system (“BIOS”) that controls certain basic functions of server 130. Random access memory (RAM) 214, Input/Output (I/O) adapter 218 and communications adapter 234 may also be coupled to system bus 212. It should be noted that software components, including operating system 240 and application 250, may be loaded into RAM 214 which may be server's 130 main memory. I/O adapter 218 may be a small computer system interface (“SCSI”) adapter that communicates with disk unit 220, e.g., disk drive. It is noted that the program of the present invention that may create and manage a development environment that mimics the target environment where the software application will be implemented as described in FIGS. 3-8 may reside in disk unit 220 or in application 250. Communications adapter 234 interconnects bus 212 with network 120 thereby enabling server 130 to communicate with client 110.

Implementations of the invention include implementations as a computer system programmed to execute the method or methods described herein and as a computer program product. According to the computer system implementations, sets of instructions for executing the method or methods are resident in the random access memory 214 of one or more computer systems configured generally as described above. Until required by server 130, the set of instructions may be stored as a computer program product in another computer memory, for example, in disk drive 220 (which may include a removable memory such as an optical disk or floppy disk for eventual use in disk drive 220). Furthermore, the computer program product can also be stored at another computer and stored or transmitted (or a portion thereof) when desired to the user's workstation or accessed by a user via a network or by an external network such as the Internet. One skilled in the art would appreciate that the physical storage of the sets of instructions physically changes the medium upon which it is stored so that the medium carries computer readable information. The change may be electrical, magnetic, chemical or some other physical change.

FIG. 3—Process Flow Diagram for Creating and Managing a Development Environment that Mimics the Target Environment

Process flow diagram 300 for creating and managing a development environment that mimics the target environment where the software application will be implemented may comprise a plurality of sub-processes 301-307. As stated in the Background Information section, many developers of software applications establish or arrange a development environment that may not be compliant with the target environment that implements the built software application. Furthermore, developers of software applications are often not aware of the required system updates to ensure that the development environment meets customers' standards for security, virus protection, access control, etc. As a result, software applications have been developed and deployed without adequately testing the software applications in the target environment. Consequently, these software applications may fail in the target environment resulting in a significant amount of code modification, design changes and/or additional testing. It would therefore be desirable to develop a process that significantly reduces the costs of correcting problems after the software application has been deployed because the software application is incompatible with the target environment. Process flow 300 is a process for creating and managing a development environment that mimics the target environment using control information, e.g., client standards for the hardware and software components in the target environment, as described below thereby reducing the number of problems that need to be corrected after the software application has been deployed. Furthermore, process flow 300 provides monitoring of the development environment to detect violated conditions of the control information thereby providing early notification of violation of the conditions as specified by the control information prior to the deployment of the software application. By receiving early notification of violations of the conditions as specified by the control information, the development environment and/or software application may be updated thereby reducing the costs of correcting problems after the software application has been deployed because the software application is incompatible with the target environment.

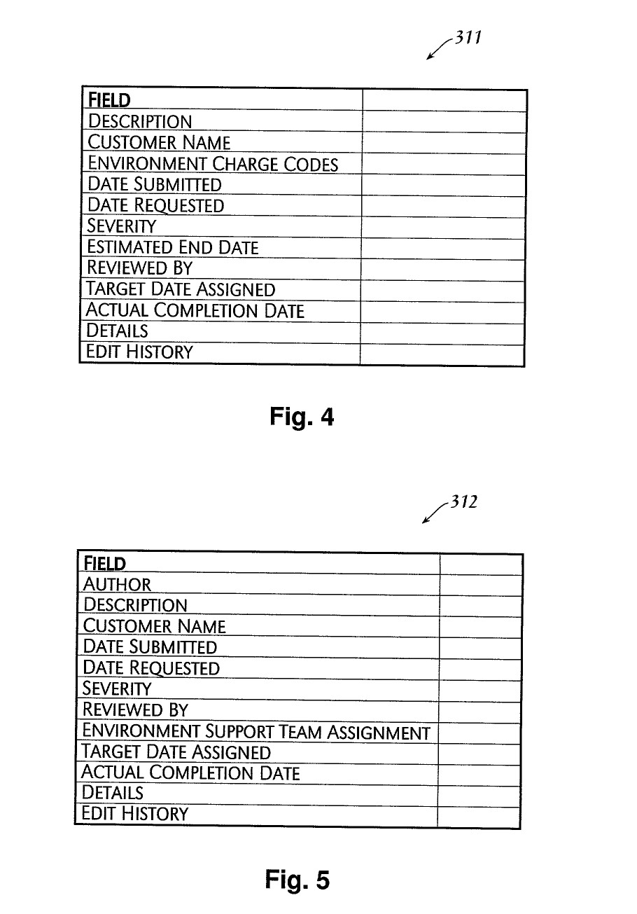

Referring to FIG. 3, sub-process 301 may refer to the sub-process for receiving a request issued from a customer, developer or team of developers of client 110 (FIG. 1) to server 130 (FIG. 2). Sub-process 301 may receive as input a development environment request 311, a change request 312 or a problem report 313. As stated above, “development environment request” 311 may comprise a description of the development environment and the software application to be developed as illustrated in FIG. 4. FIG. 4 illustrates an embodiment of the present invention of development environment request 311.

Referring to FIG. 4, development environment request 311 may comprise a plurality of fields such as a description, customer name, environment charge codes, data submitted, date requested, severity, estimated end date, reviewed by, target date assigned, actual completion date, details and edit history field. The description field may be a brief description of the development environment required to build the software application. The customer name field may refer to the name of the customer. The environment charge codes field may refer to the codes associated with charges to be paid by the customer. These charge codes may be entered by the developers. The date submitted field may refer to the date the request was submitted. The date requested field may refer to the date that the development environment is to be available which may be determined by the developers. The severity field may refer to the urgency of the request. The estimated end date field may refer to the date when the development environment may no longer be required to build the software application. The reviewed by field may refer to the developer or team of developers to review the request. The target date assigned field may refer to the initial target date of completing the development environment which may be determined by the developer or team of developers who reviewed the request. The actual completion date field may refer to the date the development environment was actually completed. The details field may refer to specific configuration details such as the hardware and software components required to build the software application. The edit history field may refer to a historical summary of the edits to development environment request 311.

A “change request” 312 may refer to a description of the change in the development environment to be implemented as illustrated in FIG. 5. FIG. 5 illustrates an embodiment of the present invention of change request 312. Referring to FIG. 5, the change request may compromise a plurality of fields such as an author, a description, customer name, date submitted, date requested, severity, reviewed by, environment support team assignment, target date assigned, actual completion date, details and edit history field. The author field may refer to the name of the individual, e.g., developer, team of developers, customer, filling out the change request. The description field may be a brief description of the change request including the reasons and justifications for the change. The customer name field may refer to a name of the customer. The date submitted field may refer to the date the request was submitted. The date requested field may refer to the date on which the change to the development environment is to be available. The severity field may refer to the urgency of the request. The reviewed by field may refer to the developer or team of developers to review the request. The environment support team assignment field may refer to a team of developers assigned to develop the development environment. The target date assigned field may refer to the initial target date of completing the requested change in the development environment which may be determined by the developer or team of developers who review the request. The actual completion date field may refer to the date the requested change was actually implemented. The details field may refer to the specific configuration details such as the hardware or software components in the development requirement requested to be changed. The edit history field may refer to a historical summary of the edits to the change request.

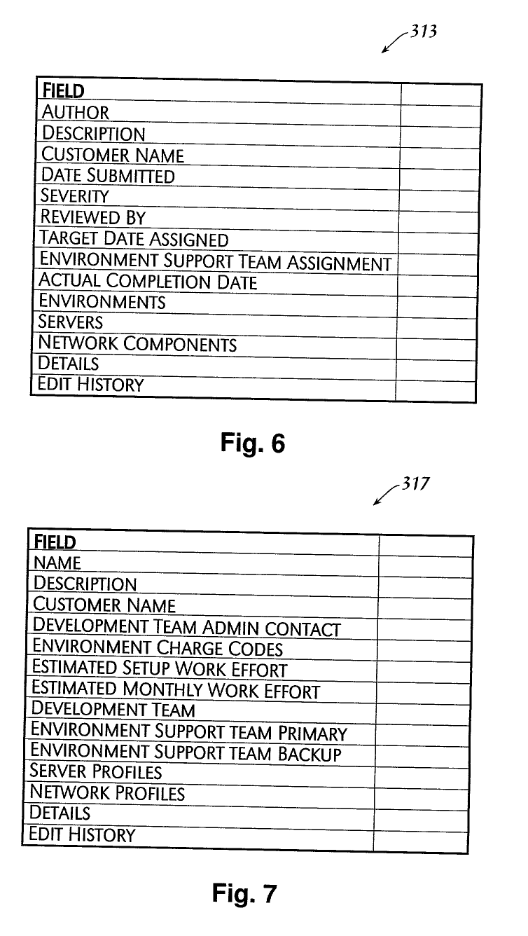

A problem report 313, as illustrated in FIG. 6 in an exemplary embodiment, may refer to a description of a problem detected in the development environment including a reference to the particular development environment, the severity of the problem and contact details provided by the developer or team of developers assigned to develop the development environment. Problem report 313 may comprise a plurality of fields such as an author, description, customer name, date submitted, severity, reviewed by, target date assigned, environment support team assignment, actual completion date, environments, servers, network components, details and edit history field. The author field may refer to the issuer of problem report 313 such as a developer assigned to the development environment. The description field may be a brief description of the problem with the development environment including a suspected cause. The customer name field may refer to the name of the customer. The date submitted field may refer to the date the report was submitted. The severity field may refer to the urgency of the problem to be solved. The target date assigned field may refer to the initial target date of solving the problem reported which may be determined by the developer or team of developers who reviewed the report. The environment support team assignment field may refer to the developer or a team of developers selected to correct the problem reported. The actual completion date field may refer to the date the problem reported was actually fixed. The environments field may refer to the particular development environment experiencing the problem. The servers field may refer to the server(s), if any, that are experiencing problems. The network components field may refer to the network component(s), if any, that are experiencing problems. The details field may refer to specific configuration details required to correct the problem. The edit history field may refer to a historical summary of the edits to the problem report.

Sub-process 301 may output the request, e.g., environment request 311, change request 312, problem report 313, to sub-process 302 to review the request as indicated by data flow 318. Upon review of the request, the request may be rejected, held, returned to the requester or assigned, as discussed further below.

Sub-process 302 may receive as control information an environment profile 317, a server profile 315, a network component profile 316 and/or the conditions, e.g., customer standards for the hardware and software components in the target environment, contract conditions, etc., stated in a statement of work 314. The control information may be used by sub-process 302 to manage how to handle the request, e.g., environment request 311, change request 312 and problem report 313, as discussed further below. Furthermore, sub-process 302 may employ resources to use the control information to manage how to handle the request. One such resource is the environment support team 327 which may refer to the developer or team of developers assigned to create and manage the development environment in question.

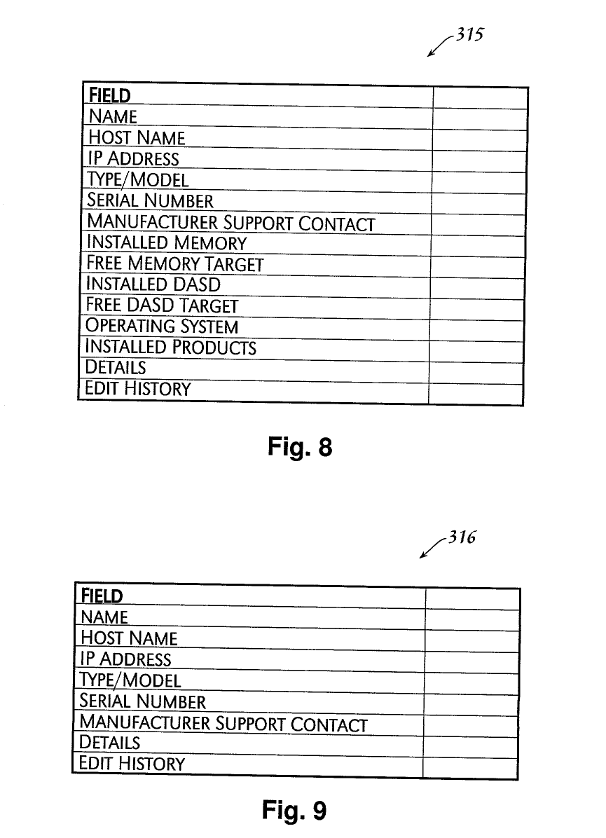

As stated above, sub-process 302 may use environment profile 317 to control how to handle the received request. Environment profile 317 may refer to a description of the development environment including the hardware and software components of the development environment as well as the software application to be developed and project business and financial data, as illustrated in FIG. 7. FIG. 7 illustrates an embodiment of the present invention of environment profile 317. Environment profile 317 may comprise a plurality of fields such as a name, description, customer name, development team administration contact, environment charge codes, estimated setup work effort, estimated monthly work effort, development team, environment support team primary, environment support team backup, server profiles, network component profiles, details and edit history field. The name field may refer to a unique name assigned to the development environment in question. The description field may be a brief description of the development environment including its characteristics. The customer name field may refer to the name of the customer. The development team administration contact field may refer to the team of developers who are the primary contact for any problems, questions, etc., regarding the development environment and are authorized to submit changes to the development environment as well as approve any changes to the development environment. The environment charge codes field may refer to the codes associated with charges to be paid by the customer. These charge codes may be entered by the development team contact. The estimated setup work effort field may refer to the estimated number of hours required to build the development environment. The estimated monthly work effort field may refer to the estimated hours required to provide support for the development environment on a monthly basis. The development team field may refer to the team of developers authorized to submit changes to the development environment as well as approve any changes to the development environment. The environment support team primary field may refer to the developer in the development team that is the primary contact. The environment support team backup field may refer to the developer in the development team that is the backup contact. The server profiles field may identify all server components within the development environment. Each identified server may have a profile associated with it as discussed in conjunction with FIG. 8. The network component profiles field may identify all network components within the development environment. Each identified network component may have a profile associated with it as discussed in conjunction with FIG. 9. The details field may refer to specific configuration details of the development environment. The edit history field may refer to a historical summary of the edits to the environment profile.

Server profile 315 may describe the hardware and software configuration data for an individual server used in the development environment as illustrated in FIG.

8. FIG. 8 illustrates an embodiment of the present invention of server profile 315. Server profile 315 may comprise a plurality of fields such as a name, host name, Internet Protocol (IP) address, type/model, serial number, manufacturer support contact, installed memory, free memory target, installed Direct Access Storage Device (DASD), free DASD target, operating system, installed products, details and edit history field. The name field may refer to a unique name assigned to the server in question. The host name field may refer to the network host name of the device. The IP address field may refer to the IP address of the server in question. The type/model field may refer to the manufacturer identification number. The serial number field may refer to the unit identification number. The manufacturer support contact field may refer to the phone number and/or web link to a manufacturer's product support group. The installed memory field may refer to the amount of physical memory currently installed. The free memory target field may refer to the percentage of memory in the server that may be utilized. The installed DASD field may refer to the amount of physical disk(s) space of the DASD. The free DASD target field may refer to the percentage of disk space that may be utilized. The operating system field may refer to the name, version, etc. of the operating system of the server. The installed products field may refer to the name and version of a product, e.g., Java C++ development tools, support products, required for a particular development environment. The details field may refer to specific configuration details of the server. The edit history field may refer to a historical summary of the edits to the server profile.

Network component profile 316 may describe the hardware and software configuration data for any dedicated network component used in the development environment, as illustrated in FIG. 9. FIG. 9 illustrates an embodiment of the present invention of network component profile 316. Network component profile 316 may comprise a plurality of fields such as a name, host name, Internet Protocol (IP) address, type/model, serial number, manufacturer support contact, details and edit history field. The name field may refer to the name of the network component. The host name field may refer to the network host name of the device. The IP address field may refer to the IP address of the network component. The type/model field may refer to the manufacturer identification number. The serial number field may refer to the unit identification number. The manufacturer support contact field may refer to the phone number and/or web link to a manufacturer's product support group. The details field may refer to specific configuration details of the network component. The edit history field may refer to a historical summary of the edits to the network component profile.

Furthermore, sub-process 302 may further receive as control information the conditions stated in the statement of work, e.g., customer standards for the hardware and software components in the target environment, contract conditions, etc. A statement of work may refer to the document that provides the detailed description of the project to be completed by the developers.

As stated above, sub-process 302 may receive control information to manage how to handle the request, e.g., environment request 311, change request 312 and problem report 313. The request received by sub-process 302 may be rejected if the request is not submitted by an authorized customer, an authorized developer or an authorized team of developers or if the request is not in compliance with a condition(s) of the statement of work as indicated by flow 319. The rejected request may be returned to the requester as indicated by flow 319. Further, the request received by sub-process 302 may be held if there are issues that need to be resolved as indicated by flow 333. For example, the request may be held to ensure that particular contract conditions are met. Furthermore, the request received by sub-process 302 may be returned to the requester if the request is not complete, e.g., additional information is required, as indicated by flow 320. Furthermore, the request submitted by an authorized customer or developer or team of developers that contains all the required information as well as satisfying all the conditions of the statement of work may be transmitted to sub-process 303 to be assigned to the responsible development team as indicated by flow 321.

Sub-process 303 may be the sub-process that assigns the approved request to one or more developers, e.g., a responsible development team. Sub-process 303 may receive as input the request approved in sub-process 302. Sub-process 303 may use environment support team 327 as a resource to determine the responsible development team based on the control information provided by statement of work 314, server profile 315, network component profile 316 and/or environment profile 317. Upon assigning the appropriate development team, the request may be transmitted to sub-process 304 to be processed as indicated by flow 322.

Sub-process 304 may be the sub-process that processes the approved request by the responsible development team of environment support team 327. Sub-process 304 may receive as input the request that is ready to be processed by the responsible development team in accordance with the control information provided by statement of work 314, server profile 315, network component profile 316 and/or environment profile 317. Upon processing the request, the request may be completed as indicated by flow 323. Furthermore, sub-process 304 may update any changes, if any, to the development environment in environment profile 317 as indicated by flow 326. Furthermore, sub-process 304 may update changes, if any, to server profile 315 as indicated by flow 324. Further, sub-process 304 may update changes, if any, to network component profile 316 as indicated by flow 325.

Sub-processes 301-304 as described above may occur in a synchronous manner. During their operation, sub-processes 305-307 as described below may occur in an asynchronous manner configured to detect and notify of any violated conditions of the control information, e.g., statement of work 314, thereby providing early notification of violation of the conditions as specified by the control information prior to the deployment of the software application. By receiving early notification of violations of the conditions as specified by the control information, the development environment and/or software application may be updated thereby reducing the costs of correcting problems after the software application has been deployed because the software application is incompatible with the target environment.

Sub-process 305 may refer to the sub-process that continuously monitors the development environment including but not limited to the hardware components, e.g., servers, and the software components, e.g., operating systems, of the development environment. Sub-process 305 may monitor the development environment via automated monitoring tools 328. Automated monitoring tools 328 may be configured to monitor particular operating conditions of the development environment. For example, automated monitoring tools 328 may be configured to monitor the utilization of the memory space or physical disk space of one or more servers in the development environment. Using the conditions as specified in the control information, e.g., server not to utilize 80% of its memory space as stated in server profile 315, automated monitoring tools 328 may monitor these conditions to determine if a condition has been violated.

Once automated monitoring tools 328 has determined that a condition has been violated, sub-process 305 may be configured to assign a severity level associated with the violated condition. An exemplary table of different levels of severity levels that may be assigned by sub-process 305 including the determining factors that may be utilized by sub-process 305 to assign a severity level is provided in Table I.

TABLE I

| Severity Level | Determining Factors |
|---|---|
| 1 | One or more development elements |
| | violate a condition. Development |
| | environment is completely unavailable. |
| 2 | One or more development elements |
| | violate a condition. Development |
| | environment is partially available, limited |
| | work may proceed. |
| 3 | One or more development elements |
| | violate a condition. Limited impact, |
| | work may proceed. |

As illustrated above, sub-process 305 may assign a severity level “1” when the development environment is completely unavailable. The development environment may be deemed to be completely unavailable by sub-process 305 based upon the control information. For example, suppose there are three servers, servers A, B and C, in the development environment and server A is not responding. If servers B and C are operational but unavailable, then the development environment may be deemed to be completely unavailable. Subsequently, the development environment may not be able to mimic the target environment where the software application will be implemented until the problem is corrected.

As further illustrated above, sub-process 305 may assign a severity level “2” when the development environment is partially unavailable. For example, suppose there are three servers, servers A, B and C, in the development environment and server B is not responding. If servers A and C are operational but cannot access some of the software components of the development environment until the problem with server B is fixed, then the development environment may be deemed to be partially unavailable. That is, the development environment may be able to partially mimic the target environment while the problem with server B is being fixed.

As further illustrated above, sub-process 305 may assign a severity level “3” when the violated condition has a limited impact on the development environment. For example, suppose there are three servers, servers A, B and C, in the development environment and automated monitoring tools 328 detected that the available disk space on server B has reached a warning level as specified in the server profile for server B. The development environment may be able to continue to mimic the target environment while the problem is being corrected and hence the violated condition has a limited impact on the development environment.

Once sub-process 305 has assigned a severity level to the violated condition, sub-process 305 may indicate the violated condition in a report as indicated in flow 329 which may then be transmitted to sub-process 307 to be transmitted to the customer as described in greater detail below. Further, sub-process 305 may be configured to determine the appropriate developer or team of developers to be notified of the violated condition based on the control information, e.g., environment profile 317, server profile 315, network component profile 316. Sub-process 305 may further issue a notification request to sub-process 306 to notify the appropriate developer or team of developers of the violated condition as indicated by flow 330. That is, the notification request may be a request to notify the appropriate developer or team of developers as identified using the control information, e.g., environment profile 317, server profile 315, network component profile 316, of the problem identified by sub-process 305.

Sub-process 306 may notify the appropriate developer or team of developers of the problem as identified by sub-process 305 according to the contact information provided in the control information, e.g., environment profile 317, server profile 315, network component profile 316. For example, environment profile 317 may specify to notify the developer or team of developers in question via e-mail. In another example, environment profile 317 may specify to notify the developer or team of developers in question by being paged. It is noted that there are numerous means of notifying the appropriate developer or team of developers of the problem identified by sub-process 305 and that such means would be recognized by an artisan of ordinary skill in the art. It is further noted that embodiments employing such means would fall within the scope of the present invention. Sub-process 306 may further be configured to notify the customer immediately of a problem deemed serious, e.g., problem with a severity level of “1”, using a variety of means as discussed above.

As stated above, sub-process 305 may transmit an indication of a violation of a condition to be inserted in a report to sub-process 307 as indicated by flow 329. Sub-process 307 may be configured to also receive as input the status of the development environment from automated monitoring tools 328 as indicated by flow 335. Automated monitoring tools 328 may be configured to periodically, e.g., once every hour, transmit information to sub-process 307 regarding the status of the development environment including information that the hardware and software components of the development environment are operating in order. Sub-process 307 may subsequently be configured to issue a report to the customer indicating the status of the project defined in statement of work 314 where the report may include violated conditions as reported by sub-process 305 as well as the status details of the development environment provided by automated monitoring tools 328 as indicated by flow 334. The report may be issued to the customer during any time frame, e.g., periodically, using any means, e.g., e-mail, mail, etc. It is noted that the means for issuing the report to the customer regarding the status of the project defined in statement of work 314 would be recognized by an artisan of ordinary skill in the art. It is further noted that embodiments employing such means would fall within the scope of the present invention.

It is noted that certain sub-processes of process flow 300 such as sub-processes 301, 305-307 may be implemented by a program in server 130 residing in application 250 (FIG. 2) or disk unit 220 (FIG. 2).

Although the system, method and computer program product are described in connection with several embodiments, it is not intended to be limited to the specific forms set forth herein, but on the contrary, it is intended to cover such alternatives, modifications and equivalents, as can be reasonably included within the spirit and scope of the invention as defined by the appended claims. It is noted that the headings are used only for organizational purposes and not meant to limit the scope of the description or claims.

1. A method for creating and managing a development environment that mimics a target environment where a software application will be implemented comprising the steps of:
receiving a first request comprising a description of said development environment and said software application to be developed, wherein said development environment comprises hardware components and software components;
reviewing said first request in accordance with control information for managing said first request;
assigning said first request to one or more developers;
processing said first request;
establishing said development environment upon said processing said first request; and
monitoring said development environment asynchronously for violations of conditions established by said control information.

2. The method as recited in claim 1 further comprising the steps of:
identifying a violation of a condition; and
notifying a developer of said violated condition.

3. The method as recited in claim 2 further comprising the steps of:
inserting information of said violation of said condition in a report; and
issuing said report to a customer.

4. The method as recited in claim 1 further comprising the steps of:
inserting information on a status of said development environment in a report; and
issuing said report to a customer.

5. The method as recited in claim 1, wherein said control information comprises one or more of the following: a statement of work, a profile of a server implemented in said development environment, a profile of a network component implemented in said development environment, and a profile of said development environment.

6. The method as recited in claim 5, wherein said statement of work comprises standards for hardware components and software components in said target environment, wherein said statement of work comprises contract conditions.

7. The method as recited in claim 5, wherein said server profile comprises a description of said server implemented in said development environment.

8. The method as recited in claim 5, wherein said network component profile comprises a description of said network component implemented in said development environment.

9. The method as recited in claim 5, wherein said profile of said development environment comprises a description of said hardware components and said software components of said development environment, wherein said profile of said development environment comprises a description of said software application to be developed.

10. The method as recited in claim 1, wherein said processing said first request comprises updating a profile of a server implemented in said development environment, wherein said server profile comprises a description of said server implemented in said development environment.

11. The method as recited in claim 1, wherein said processing said first request comprises updating a profile of a network component implemented in said development environment, wherein said network component profile comprises a description of said network component implemented in said development environment.

12. The method as recited in claim 1, wherein said processing said first request comprises updating profile of said development environment, wherein said profile of said development environment comprises a description of said hardware components and said software components of said development environment, wherein said profile of said development environment comprises a description of said software application to be developed.

13. The method as recited in claim 1 further comprising the step of:
receiving a second request, wherein said second request comprises a request to implement a change in said development environment.

14. The method as recited in claim 1 further comprising the step of:
receiving a second request, wherein said second request comprises a request to correct a problem detected in said development environment.

15. A computer program product embodied in a machine readable medium for creating and managing a development environment that mimics a target environment where a software application will be implemented comprising the programming steps of:
receiving a first request comprising a description of said development environment and said software application to be developed, wherein said development environment comprises hardware components and software components, wherein said first request is reviewed in accordance with control information for managing said first request, wherein said first request is processed, wherein upon processing said first request said development environment is established; and
monitoring said development environment asynchronously for violations of conditions established by said control information.

16. The computer program as recited in claim 15 further comprising the programming steps of:
identifying a violation of a condition; and
notifying said a developer of said violated condition.

17. The computer program as recited in claim 16 further comprising the programming steps of:
inserting information of said violation of said condition in a report; and
issuing said report to a customer.

18. The computer program product as recited in claim 15 further comprising the programming steps of:
inserting information on a status of said development environment in a report; and
issuing said report to a customer.

19. The computer program product as recited in claim 15, wherein said control information comprises a statement of work, wherein said statement of work comprises standards for hardware components and software components in said target environment, wherein said statement of work comprises contract conditions.

20. The computer program product as recited in claim 15, wherein said control information comprises one or more of the following: a statement of work, a profile of a server implemented in said development environment, a profile of a network component implemented in said development environment, and a profile of said development environment.

21. The computer program product as recited in claim 20, wherein said server profile comprises a description of said server implemented in said development environment.

22. The computer program product as recited in claim 20, wherein said network component profile comprises a description of said network component implemented in said development environment.

23. The computer program product as recited in claim 20, wherein said profile of said development environment comprises a description of said hardware components and said software components of said development environment, wherein said profile of said development environment comprises a description of said software application to be developed.

24. The computer program product as recited in claim 15 further comprising the programming step of:
receiving a second request, wherein said second request comprises a request to implement a change in said development environment.

25. The computer program product as recited in claim 15 further comprising the programming step of:
receiving a second request, wherein said second request comprises a request to correct a problem detected in said development environment.

26. A system, comprising:
a memory unit operable for storing a computer program operable for creating and managing said development environment that mimics said target environment where said software application will be implemented; and
a processor coupled to said memory unit, wherein said processor, responsive to said computer program, comprises:
circuitry operable for receiving a first request comprising a description of a development environment and a software application to be developed in a target environment, wherein said development environment comprises hardware components and software components, wherein said first request is reviewed in accordance with control information for managing said first request, wherein said first request is processed, wherein upon processing said first request said development environment is established; and
circuitry operable for monitoring said development environment asynchronously for violations of conditions established by said control information.

27. The system as recited in claim 26, wherein said processor further comprises:
circuitry operable for identifying a violation of a condition; and
circuitry operable for notifying a developer of said violated condition.

28. The system as recited in claim 27, wherein said processor further comprises:
circuitry operable for inserting information of said violation of said condition in a report; and
circuitry operable for issuing said report to a customer.

29. The system as recited in claim 26, wherein said processor further comprises:
circuitry operable for inserting information on a status of said development environment in a report; and
circuitry operable for issuing said report to a customer.

30. The system as recited in claim 26, wherein said control information comprises one or more of the following: a statement of work, a profile of a server implemented in said development environment, a profile of a network component implemented in said development environment, and a profile of said development environment.

31. The system as recited in claim 30, wherein said statement of work comprises standards for hardware components and software components in said target environment, wherein said statement of work comprises contract conditions.

32. The system as recited in claim 30, wherein said server profile comprises a description of said server implemented in said development environment.

33. The system as recited in claim 30, wherein said network component profile comprises a description of said network component implemented in said development environment.

34. The system as recited in claim 30, wherein said profile of said development environment comprises a description of said hardware components and said software components of said development environment, wherein said profile of said development environment comprises a description of said software application to be developed.

35. The system as recited in claim 26, wherein said processor further comprises:
circuitry operable for receiving a second request, wherein said second request comprises a request to implement a change in said development environment.

36. The system as recited in claim 26, wherein said processor further comprises:
circuitry operable for receiving a second request, wherein said second request comprises a request to correct a problem detected in said development environment.

37. A system, comprising:
means for receiving a first request comprising a description of a development environment and a software application to be developed in a target environment, wherein said development environment comprises hardware components and software components, wherein said first request is reviewed in accordance with control information for managing said first request, wherein said first request is processed, wherein upon processing said first request said development environment is established; and
means for monitoring said development environment asynchronously for violations of conditions established by said control information.

38. The system as recited in claim 37, wherein said system further comprises:
means for identifying a violation of a condition; and
means for notifying a developer of said violated condition.

39. The system as recited in claim 38, wherein said system further comprises:
means for inserting information of said violation of said condition in a report; and
means for issuing said report to a customer.

40. The system as recited in claim 37, wherein said system further comprises:
means for inserting information on a status of said development environment in a report; and
means for issuing said report to a customer.

41. The system as recited in claim 37, wherein said control information comprises one or more of the following: a statement of work, a profile of a server implemented in said development environment, a profile of a network component implemented in said development environment, and a profile of said development environment.

42. The system as recited in claim 41, wherein said statement of work comprises standards for hardware components and software components in said target environment, wherein said statement of work comprises contract conditions.

43. The system as recited in claim 41, wherein said server profile comprises a description of said server implemented in said development environment.

44. The system as recited in claim 41, wherein said network component profile comprises a description of said network component implemented in said development environment.

45. The system as recited in claim 41, wherein said profile of said development environment comprises a description of said hardware components and said software components of said development environment, wherein said profile of said development environment comprises a description of said software application to be developed.

46. The system as recited in claim 37, wherein said system further comprises:
means for receiving a second request, wherein said second request comprises a request to implement a change in said development environment.

47. The system as recited in claim 37, wherein said system further comprises:
means for receiving a second request, wherein said second request comprises a request to correct a problem detected in said development environment.
